(19) United States
(12) Patent Application Publication
(10) Pub. No.: US 2008/0127993 A1
(43) Pub. Date: Jun. 5, 2008

(54) Filter Regeneration Using Plasma

(75) Inventors: Robert Graifman, Short Hills, NJ (US); Stephen L. Kaplan, San Carlos, CA (US); Gerald B. Smith, West Chester, PA (US)

Correspondence Address: RAUBVOGEL LAW OFFICE, 820 LAKEVIEW WAY, REDWOOD CITY, CA, 94062, US

(73) Assignee: TOTALCAT GROUP, INC., Newark, NJ (US)

(21) Appl. No.: 11/745,809

(22) Filed: May 8, 2007

Related U.S. Application Data
(60) Provisional application No. 60/861,543, filed on Nov. 30, 2006.

(51) Int. Cl. C25F 1/00; B08B 13/00; H05H 1/00; B08B 5/00

(52) U.S. Cl. 134/1.1; 134/103.1; 134/104.2; 134/105; 134/56 R; 134/94.1

(57) ABSTRACT

An emission control device, such as a filter, is regenerated by exposure to plasma. Plasma breaks down carbon-based residues, such as soot, to enable the filter to be easily cleaned and regenerated without subjecting the filter to heat-related stress associated with thermal regeneration methods. Secondary plasma generation is used to overcome impediments caused by the presence of a metallic housing and/or metal-containing materials such as a washcoat or mesh in the filter.

### CROSS-REFERENCE TO RELATED APPLICATION

This patent application claims priority from U.S. Provisional Application Ser. No. 60/861,543 for “METHODS FOR TREATING, CLEANING AND REGENERATING EMISSION CONTROL DEVICES”, filed Nov. 30, 2006, the disclosure of which is incorporated herein by reference.

### FIELD OF THE INVENTION

The present invention relates to cleaning and regenerating emission control devices such as particulate filters, and more particularly to the use of plasma to clean and regenerate such devices.

### DESCRIPTION OF THE RELATED ART

Emission control devices, such as particulate filters, are used in many applications including vehicles, to limit the amount of particulate matter discharged into the environment. Such devices are used, for example, to reduce emissions originating from an internal combustion engine such as a diesel engine. Substrate materials for particulate filters are often fashioned from ceramics such as cordierite and silicon carbide, or in certain cases, metal monolith or mesh materials.

Over time, the accumulation of ash, soot, and other residues can interfere with operation of particulate filters, for example by causing excessive back-pressure resulting in reduced filtration efficiency and engine efficiency. In order to operate properly, particulate filters must be periodically regenerated via a cleaning process that removes trapped residue from the filter.

Existing regeneration techniques generally involve application of heat to break down the organic components in soot such as carbon. Once the carbon has been oxidized to substances such as CO₂, it can be removed from the device.

Several problems arise from the use of heat to regenerate filters. First, thermal stress can shorten the lifespan of filters by introducing wear and tear and fracture failures in the substrate material. Heat application can also be a time-consuming operation, sometimes requiring up to twenty hours to regenerate each filter. In some cases, active filter elements cannot easily be removed from their canisters or other housings, requiring that the entire assembly be exposed to potentially damaging heat. Thermal methods can also emit undesirable exhaust by-products that require remediation. Finally, thermal regeneration methods can be expensive, both in terms of the specialized equipment needed and the attendant energy costs.

What is needed, therefore, is a technique for regenerating filters that overcomes the limitations of thermal methods. What is further needed is a method that accomplishes the goal of breaking down carbon and other residues in filters without causing device failures or other modes of wear and tear associated with the thermal approach. What is further needed is a filter regeneration technique that provides improved efficiency and cost-effectiveness.

### SUMMARY OF THE INVENTION

According to the techniques of the present invention, filter regeneration is accomplished by exposing the filter (or other emission control device) to a plasma atmosphere. Plasma oxidizes carbon-based residues, such as soot, to enable a filter to be easily cleaned and regenerated. Plasma avoids the limitations of thermal methods, in particular by reducing or eliminating heat-related stresses and by improving efficiency and expense associated with filter regeneration.

The present invention also provides improved plasma application techniques that overcome obstacles to the use of plasma in filter regeneration. Specifically, if the filter element is housed within a metallic canister and cannot easily be removed, the canister can interfere with plasma excitation. Other metallic components (such as a metal-containing washcoat or mesh) can also interfere with plasma excitation in the filter element. In addition, filter geometries often include large numbers of small openings that can shorten the mean free path for particles in the plasma state, thus reducing the sustainability of the plasma.

In various embodiments, as described more fully below, these obstacles are addressed by the use of secondary or downstream plasmas, compressed gas cylinders, pressure manipulation, or some combination thereof. The present invention offers an improved filter regeneration technique that avoids the limitation of thermal methodologies and is able to function in the presence of metallic components and low-mean-free-path filter geometries.

The present invention also facilitates the use of a smaller power source than is commonly found in thermal-based systems. Furthermore, the present invention reduces or eliminates the need for exhaust remediation, since the by-products are generally limited to carbon dioxide, oxygen, and/or water. These advantages provide improved simplicity that can yield greater portability and efficiency.

### BRIEF DESCRIPTION OF THE DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1 depicts one embodiment of the present invention, wherein a primary plasma is applied to a filter within a vacuum chamber.

FIG. 2 depicts another embodiment of the present invention, wherein the vacuum chamber is custom-fitted to reduce excess volume.

FIGS. 3A and 3B depict other embodiments of the present invention, wherein the vacuum chamber is constructed from an RF-transparent material.

FIGS. 4A, 4B, 4C, and 4D depict other embodiments of the present invention, wherein the vacuum chamber is constructed from an RF-transparent material and is elongated to facilitate plasma excitation outside the filter element.

FIG. 5 depicts another embodiment of the present invention, wherein the plasma is generated outside the filter element and assembly, and is drawn through the filter device by differential pressure.

### DETAILED DESCRIPTION OF THE EMBODIMENTS

In the following description, the present invention is described in terms of an off-vehicle mechanism for regenerating diesel particulate filters using plasma. One skilled in the art will recognize that the present invention can be practiced according to other techniques as well, and that the specific details contained herein are intended to be illustrative and not limiting of the scope of the invention. For example, the present invention can be implemented as an on-vehicle or off-vehicle mechanism.

According to the techniques of the present invention, filter regeneration is accomplished by exposing the filter (or other emission control device) to plasma. Plasma breaks down at least a portion of carbon-based residues, such as soot, to low molecular weight substances such as carbon dioxide, water, and volatile hydrocarbons that can be removed by a vacuum pump. The process of the present invention thus enables the filter to be easily cleaned and regenerated. Plasma avoids the limitations of thermal methods, in particular by reducing, eliminating, and/or controlling heat-related stress and by improving efficiency and expense associated with filter regeneration.

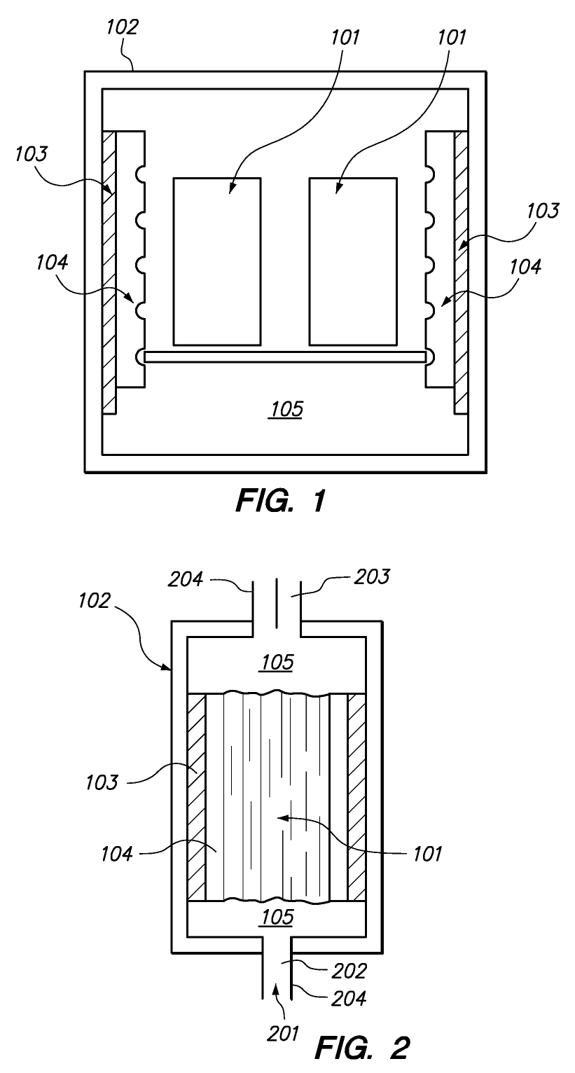

Referring now to FIG. 1, there is shown an example of an embodiment of the present invention. One or more filters 101 are positioned within vacuum chamber 102 constructed of any suitable material. In one embodiment, chamber 102 is constructed of metal. Gas 105 within chamber 102 is excited to a plasma state by activating electrodes 104 to establish an RF field within the area of chamber 102 occupied by filters 101. In this arrangement, primary plasma generation is used, meaning that the plasma is generated directly within chamber 102 between electrodes 104 and the front and back walls of chamber 102. Filters 101 are immersed in a primary plasma which is being continuously activated by virtue of the positioning of electrodes 104 adjacent to or surrounding filters 101. In one embodiment, electrodes 104 are capacitive electrodes. Dielectric 103 is provided, to insulate electrodes 104 from the walls of chamber 102. The plasma oxidizes soot and other residue within filters 101, reducing these materials to CO₂ and/or other gases that can easily be removed from filters 101.

An advantage of the implementation of FIG. 1 is that a general-purpose chamber 102 can be used, with little or no modification.

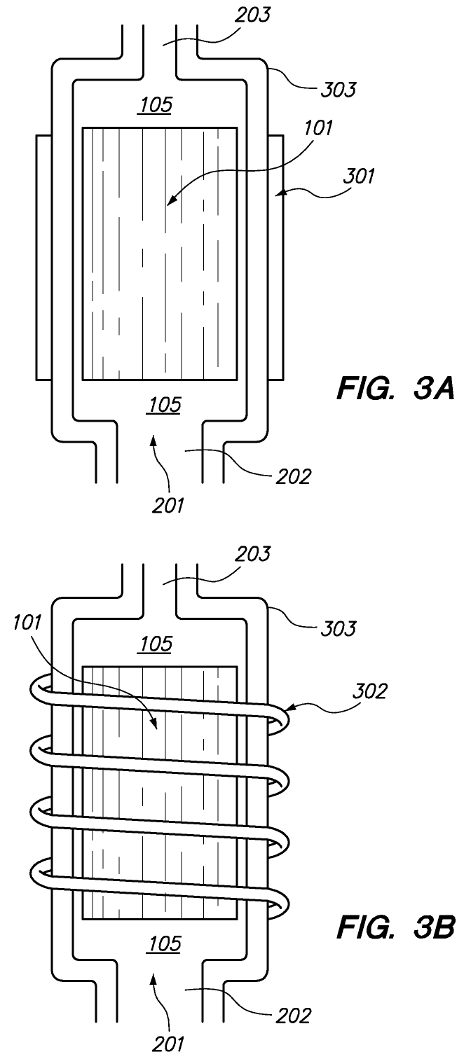

Referring now to FIG. 2, there is shown another embodiment of the present invention. Here, vacuum chamber 102 is designed so that filter 101 is situated snugly therein. Such an arrangement is particularly useful for regenerating filters 101 having a standardized size and shape. In one embodiment, chamber 102 is constructed as a metallic cylinder, for example by forming metal tubing of the appropriate diameter. Flanges 204 form openings 202, 203 at each end of chamber 102.

Chamber 102 is connected to a gas source 201 via opening 202 and to a vacuum via opening 203, so that gas 105 is pulled from opening 202 to opening 203. Gas source 201 may be, for example a compressed gas cylinder for supplying gas to chamber 102. The snug fit of filter 101 within chamber 102 ensures that gas 105 passes through filter 101 on its way from opening 202 to opening 203; no gas 105 passes around the exterior of filter 101. If desired, a sealant can be applied to help prevent leakage of gas 105 around the sides of filter 101.

Electrodes 104 generate an RF field that excites gas 105 as it passes through filter 101. In one embodiment, electrodes 104 are set up as two separate plates surrounding chamber 102, with each plate occupying approximately 100 degrees. One skilled in the art will recognize that other arrangements can be used.

By forcing gas 105 through filter 101, the arrangement of FIG. 2 generates a controlled gas-flow environment that helps to remove the residual gases and loosened particulate matter from filter 101. A further advantage to the arrangement of FIG. 2 is that it minimizes wasted space and wasted volume of gas 105; virtually all the plasma gas passes through filter 101.

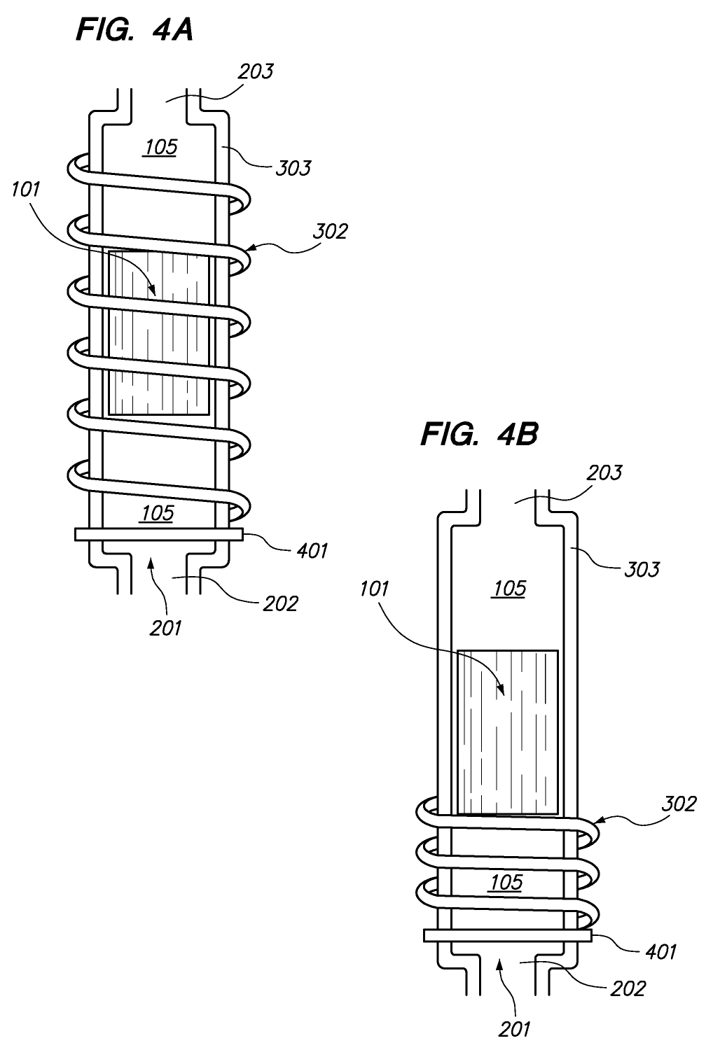

Referring now to FIG. 3A, there is shown an implementation where vacuum chamber 303 is constructed from an RF-transparent material such as glass or Pyrex. Gas source 201 provides gas 105 through opening 202, and opening 203 is connected to a vacuum. Filter 101 is situated snugly within chamber 303, so that gas 105 is forced through filter 101 and cannot pass around it.

By virtue of the RF-transparency of chamber 303, electrode 301 can be positioned outside chamber 303. This simplifies the architecture of the regeneration apparatus, since no dielectric is needed, and no feed-through aperture is needed to pass electricity through the walls of chamber 303. Accordingly, the arrangement of FIG. 3A makes it easier to maintain a vacuum or controlled-gas environment within chamber 303. In one embodiment, electrodes 104 are set up as two separate plates surrounding chamber 102, with each plate occupying approximately 100 degrees.

Referring now to FIG. 3B, there is shown an alternative embodiment similar to FIG. 3A. Here, inductive coil 302 is used to generate the RF field to excite gas 105. Again, positioning coil 302 outside chamber 303 provides an architecture where no dielectric is needed, and no feed-through aperture is needed to pass electricity through the walls of chamber 303.

For filters 101 that are housed within a metallic casing, and/or that include metal-containing mesh and/or washcoat, the metals contained therein can interfere with plasma excitation inside filter 101. In addition, certain types of filter 101 geometries may reduce the mean free path to the point where plasma cannot be satisfactorily maintained within filter 101. Thus, for either or both of these reasons, gas 105 within filters 101 may fail to excite sufficiently to attain or maintain a plasma state. Accordingly, in such a circumstance the regeneration operation may fail to achieve the desired results.

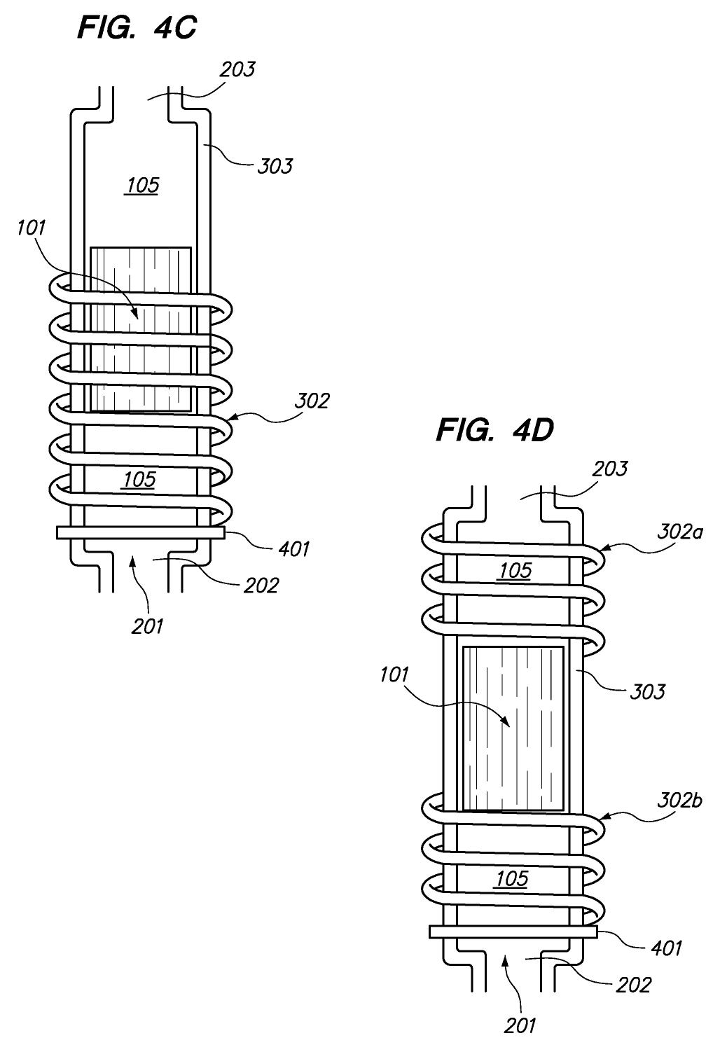

Referring now to FIGS. 4A, 4B, 4C, and 4D, there are shown implementations that address these issues. Here, chamber 303 is elongated so as to provide additional space above and/or below filter 101. Inductive coil 302 extends beyond the upper and/or lower edges of filter 101, so that an RF field is generated in these areas that are not occupied by filter 101. Thus, the RF field can excite gas 105 while it is outside filter 101, without any interference from a metallic housing or components and without any mean-free-path issues that may exist inside filter 101. Once gas 105 has been excited to a plasma state, it can be pushed through filter 101 by virtue of the gas source connection 201 and the vacuum connection 203. In one embodiment, the excited gas 105 can be alternately pushed and pulled through filter 101 by reversing the gas flow several times using gas and vacuum manifolds and switching valves (not shown). In addition air, a specific reactive or inert gas at higher pressure could also be directed through filter 101, so as to help dislodge particulate matter, thus aiding in the regeneration process. Flange 401 provides easy and full access to chamber 303 to aid in easy loading and unloading of the filter elements.

An adjoining chamber (not shown) can be provided, to capture the dislodged particulate matter; this matter can be disposed of before the gas 105 is cycled back into the main chamber 303 or exhausted to the atmosphere.

In one embodiment, back pressure can be monitored as the gas is pushed and pulled through chamber 303, so as to provide an indication as to the progress of the filter regeneration process. Once back pressure has reached a predefined threshold level, filter 101 has been sufficiently cleaned of particulate matter that it can be re-used.

FIG. 4A depicts an embodiment where coil 302 extends beyond both the upper and lower edges of filter 101, allowing plasma to be generated in both these areas. FIG. 4C depicts an embodiment where coil 302 extends beyond the lower edge of filter 101, allowing plasma to be generated below filter 101 but not above it. FIG. 4B depicts an embodiment where coil 302 is positioned so that it excites gas 105 only in the area below filter 101, but not within filter 101 or above filter 101. FIG. 4D depicts an embodiment where one coil 302A is positioned so that it excites gas 105 in the area above filter 101, and another coil 302B is positioned so that it excites gas 105 in the area below filter 101. As will be apparent to one skilled in the art, any of these variations can also be implemented using electrodes 301 similar to those depicted in FIG. 3A.

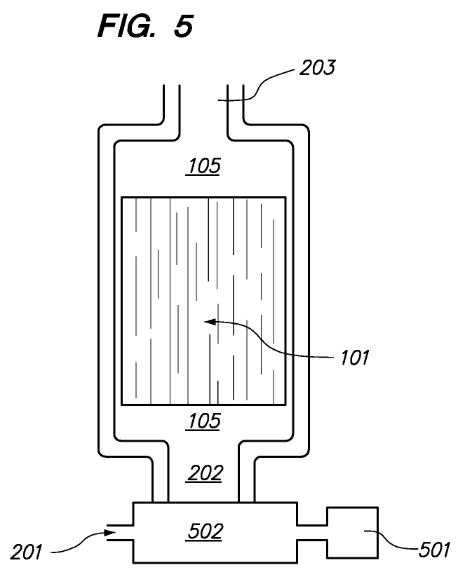

FIG. 5 depicts an embodiment wherein the plasma is generated in a separate chamber 502 outside filter element and assembly 101, and is drawn through filter 101 by differential pressure. In the particular example shown in FIG. 5, a microwave source 501 is used to generate the plasma, although one skilled in the art will recognize that other mechanisms, such as a low frequency or radio frequency source, can be used. Plasma is generated in chamber 502 and then forced through chamber 303 by providing gas at 201 and a vacuum at 203.

Microwave source 501 and plasma generation chamber 502 can be positioned at the top of chamber 303, or at the bottom. In an alternative embodiment, two microwave sources 501 and plasma generation chambers 502 are provided: one at each end of chamber 303. Microwave power sources can be less expensive than high frequency generators; furthermore, microwave generates higher frequency dissociates that can process gases into a plasma more effectively. Thus there may be benefits to using microwave energy for downstream or remote plasma system design. Also, the embodiment of FIG. 5 facilitates excitation of gas 105 outside filter 101, so as to enable sufficient plasma generation in the presence of metallic components and mean-free-path issues resulting from particular filter 101 constructions.

One skilled in the art will recognize that other electromagnetic energies can be used to create plasmas.

The techniques illustrated in FIGS. 4A, 4B, 4C, 4D, and 5 are referred to as “secondary plasma” techniques, in reference to the arrangement where plasma is generated outside filter 101 and then forced through filter 101 as part of the regeneration process. By contrast, the techniques illustrated in FIGS. 1, 2, 3A, and 3B are referred to as “primary plasma” techniques, because the plasma is generated directly within filter 101.

In some cases, filter elements cannot easily be removed from their canister or other housing, and must be regenerated in situ. If the canister is constructed from stainless steel or other RF-opaque material, the RF energy needed to excite the gas into a plasma state may not be able to penetrate into the filter elements. In one embodiment, this situation is addressed by using secondary plasma; in particular, plasma is generated outside the filter and then forced through the filter as described above. Alternatively, the stainless steel canister can be used as a ground and an electrode can be placed within the filter stack to avoid the need for the RF energy to pass through the canister; however, such a solution may be limited to filters of specific design.

The above-described embodiments are presented for illustrative purposes only. One skilled in the art will recognize that the present invention can be practiced using other techniques, arrangements, and layouts without departing from the essential characteristics as set forth in the claims.

Any of the above-described techniques can operate with any type of plasma. In one embodiment, one or more of the following gases is used: oxygen, argon, nitrous oxide, helium, carbon tetrafluoride, carbon dioxide, nitrogen trifluoride, and water vapor.

The above description includes various specific details that are included for illustrative purposes only. One skilled in the art will recognize the invention can be practiced according to many embodiments, including embodiments that lack some or all of these specific details. Accordingly, the presence of these specific details is in no way intended to limit the scope of the claimed invention.

All terms used herein are to be considered labels only, and are intended to encompass any appropriate physical quantities or other physical manifestations. Any particular naming or labeling of the various modules, protocols, features, and the like is intended to be illustrative; other names and labels can be used.

References to “one embodiment” or “an embodiment” indicate that a particular element or characteristic is included in at least one embodiment of the invention. Although the phrase “in one embodiment” may appear in various places, these do not necessarily refer to the same embodiment.

What is claimed is:

1. A system for regeneration of an emission control device, comprising:
a chamber adapted to hold an emission control device;
a gas source, for providing gas to the chamber; and
an electromagnetic source, not contained by the emission control device, for exciting the gas to a plasma state;
wherein the emission control device is exposed to the plasma.

2. The system of claim 1, further comprising a vacuum source coupled to the chamber.

3. The system of claim 1, wherein the emission control device comprises a filter.

4. The system of claim 1, wherein the emission control device comprises a diesel particulate filter.

5. The system of claim 1, wherein the gas comprises at least one selected from the group consisting of oxygen, argon, nitrous oxide, helium, carbon tetrafluoride, carbon dioxide, nitrogen trifluoride, and water vapor.

6. The system of claim 1, wherein the emission control device comprises a metallic housing.

7. The system of claim 1, wherein the emission control device comprises a metal-containing washcoat.

8. The system of claim 7, wherein the metal-containing washcoat comprises alumina supported metal particles.

9. The system of claim 7, wherein the metal-containing washcoat comprises precious metal.

10. The system of claim 1, wherein the emission control device comprises a metallic mesh.

11. The system of claim 1, wherein the electromagnetic source excites at least a portion of the gas to a plasma state in a region of the chamber external to the emission control device.

12. The system of claim 11, further comprising a pump, coupled to the chamber, for moving the plasma through the emission control device.

13. The system of claim 12, further comprising a vacuum, coupled to the chamber.

14. The system of claim 12, wherein the pump is adapted to alternate the flow of plasma between a first direction and a second, opposite direction.

15. The system of claim 14, further comprising a pressure monitor, for measuring backflow pressure resulting from moving the plasma through the emission control device.

16. The system of claim 15, wherein the pressure monitor compares the measured backflow pressure with a predefined threshold, and generates a signal responsive to the predefined threshold being reached.

17. The system of claim 16, wherein the signal from the pressure monitor is used to trigger at least one of a start point, intermediate point, and end point of regeneration of the emission control device.

18. The system of claim 1, wherein the electromagnetic source comprises at least one capacitive electrode.

19. The system of 18, wherein the at least one capacitive electrode is positioned so as to excite at least a portion of the gas within the chamber outside the emission control device.

20. The system of claim 18, wherein the at least one capacitive electrode is positioned so as to excite at least a portion of the gas outside the chamber.

21. The system of claim 1, wherein the electromagnetic source comprises at least one inductive coil.

22. The system of claim 21, wherein the at least one inductive coil is positioned so as to excite at least a portion of the gas within the chamber outside the emission control device.

23. The system of claim 21, wherein the at least one inductive coil is positioned so as to excite at least a portion of the gas outside the chamber.

24. The system of claim 1, wherein the electromagnetic source comprises at least one microwave source.

25. The system of claim 1, wherein the chamber is constructed from metal.

26. The system of claim 1, wherein the chamber is constructed from substantially RF-transparent material.

27. The system of claim 1, wherein the chamber is constructed to form a seal around the emission control device to substantially prevent gas flow around the sides of the emission control device.

28. The system of claim 1, wherein the emission control device is constructed from at least one selected from the group consisting of:
a ceramic substrate;
cordierite;
silicon carbide;
ferritic steel;
stainless steel;
aluminum titanate;
sintered metal;
mullite; and
composite shell.

29. The system of claim 1, wherein the emission control device comprises at least one selected from the group consisting of:
a wall-flow ceramic substrate;
a honeycomb configuration of alternating plugged channels;
a mesh;
a sponge;
a corrugated metal foil;
a woven mesh;
a spun mesh; and
a compressed metal mesh.

30. The system of claim 1, wherein the chamber is adapted to hold emission control devices of varying sizes and shapes.

31. The system of claim 1, wherein the chamber is adapted to hold and regenerate at least two emission control devices simultaneously.

32. The system of claim 1, further comprising an adjoining chamber for capturing particulate matter flushed from the emission control device.

33. The system of claim 32, wherein the particulate matter comprises at least one oxidation by-product.

34. The system of claim 32, wherein the particulate matter comprises at least one of ash and soot.

35. A system for regenerating a filter, comprising:
a chamber adapted to hold a filter;
a gas source, for providing gas to the chamber; and
an electromagnetic source, for exciting the gas to a plasma state;
wherein the chamber exposes the filter to the plasma.

36. A system for regeneration of an emission control device, comprising:
means for holding an emission control device;
means for providing gas to the chamber; and
means, not contained by the emission control device, for exciting the gas to a plasma state;
wherein the emission control device is exposed to the plasma.

37. The system of claim 36, wherein the gas comprises at least one selected from the group consisting of oxygen, argon, nitrous oxide, helium, carbon tetrafluoride, carbon dioxide, nitrogen trifluoride, and water vapor.

38. The system of claim 36, wherein the emission control device comprises a metallic housing.

39. The system of claim 36, wherein the emission control device comprises a metal-containing washcoat.

40. The system of claim 39, wherein the metal-containing washcoat comprises alumina supported metal particles.

41. The system of claim 39, wherein the metal-containing washcoat comprises precious metal.

42. The system of claim 36, wherein the emission control device comprises a metallic mesh.

43. The system of claim 36, wherein the means for exciting the gas excites at least a portion of the gas to a plasma state in a region external to the emission control device.

44. The system of claim 43, further comprising means for moving the plasma through the emission control device.

45. The system of claim 36, wherein the emission control device is constructed from at least one selected from the group consisting of:
a ceramic substrate;
cordierite;
silicon carbide;
ferritic steel;
stainless steel;
aluminum titanate;
sintered metal;
mullite; and
composite shell.

46. The system of claim 36, wherein the emission control device comprises at least one selected from the group consisting of:
a wall-flow ceramic substrate;
a honeycomb configuration of alternating plugged channels;
a mesh;
a sponge;
a corrugated metal foil;
a woven mesh;
a spun mesh; and
a compressed metal mesh.

47. A method for regenerating an emission control device, comprising:
situating an emission control device within a chamber;
providing gas to the chamber; and
exciting the gas to a plasma state by an electromagnetic source not contained by the emission control device; and
exposing the emission control device to the plasma.

48. The method of claim 47, wherein the gas comprises at least one selected from the group consisting of oxygen, argon, nitrous oxide, helium, carbon tetrafluoride, carbon dioxide, nitrogen trifluoride, and water vapor.

49. The method of claim 47, wherein the emission control device comprises a metallic housing.

50. The method of claim 47, wherein the emission control device comprises a metal-containing washcoat.

51. The method of claim 50, wherein the metal-containing washcoat comprises alumina supported metal particles.

52. The method of claim 50, wherein the metal-containing washcoat precious metal.

53. The method of claim 47, wherein the emission control device comprises a metallic mesh.

54. The method of claim 47, wherein exciting the gas comprises exciting at least a portion of the gas in a region external to the emission control device.

55. The method of claim 54, further comprising moving the plasma through the emission control device.

56. The method of claim 47, wherein the emission control device is constructed from at least one selected from the group consisting of:
a ceramic substrate;
cordierite;
silicon carbide;
ferritic steel;
stainless steel;
aluminum titanate;
sintered metal;
mullite; and
composite shell.

57. The method of claim 47, wherein the emission control device comprises at least one selected from the group consisting of:
a wall-flow ceramic substrate;
a honeycomb configuration of alternating plugged channels;
a mesh;
a sponge;
a corrugated metal foil;
a woven mesh;
a spun mesh; and
a compressed metal mesh.
